(19) United States
(12) Patent Application Publication
(10) Pub. No.: US 2007/0126599 A1
(43) Pub. Date: Jun. 7, 2007

(54) Solar power traffic light

(76) Inventors: Henry Gembala, Delray Beach, FL (US); David Gembala, Delray Beach, FL (US)

Correspondence Address: ROBERT M. DOWNEY, P.A., 6751 N. FEDERAL HWY., SUITE 300, BOCA RATON, FL, 33487, US

(21) Appl. No.: 11/607,493

(22) Filed: Dec. 1, 2006

Related U.S. Application Data
(60) Provisional application No. 60/742,173, filed on Dec. 2, 2005.

(51) Int. Cl. G08G 1/095

(52) U.S. Cl. 340/908

(57) ABSTRACT

A traffic signal apparatus is provided with solar panels, a battery source for powering light directional signals during a power outage and a charger linked to the solar panels for re-energizing the battery source. Changing of the light directional signals (i.e. red, yellow, green, arrow) is controlled by a timer connected to the battery power source. In a preferred embodiment, one or more 12 volt batteries, such as those used in an automobile, are connected in series for powering the light signals. The batteries, solar panel(s), charger, connecting cables and the timer may be installed to an existing conventional traffic light signal or, alternatively, on a temporary traffic light signal supported on a post for placement on the ground, preferably in the middle of the road, such as at an intersection.

### BACKGROUND OF THE INVENTION

This application is based on provisional patent application Ser. No. 60/742,173 filed on Dec. 2, 2005.

### FIELD OF THE INVENTION

This invention relates to traffic signals and, more particularly, to a solar power traffic light signal for use during a power outage or in the event of destruction of an existing traffic signal.

### DISCUSSION OF THE RELATED ART

Traffic signals are essential in order to permit safe and efficient flow of traffic at intersections, particularly in densely populated areas where there is a high volume of traffic. When there is a power outage, due to a storm, accident, construction, etc, the flow of traffic at an intersection can become chaotic, resulting in traffic tie-ups and possibly accidents. The disorderly situation often causes tempers to flare, as drivers lose their patience and become angry at those who do not obey the rules of the road.

In order to maintain order at intersections that have lost use of traffic signals, police officers are called to the locations to direct traffic using hand signals. While this helps to improve safe and orderly flow of traffic, the cost of using police officers for directing traffic can be substantial. Also, use of police officers for directing traffic, particularly for an extended period of time, diverts these officers from their regular duties. Moreover, because many people are not accustomed to hand signals, some drivers are slow to react to the directions of police officers, and, as a result, traffic does not always flow as normal.

In the event of a large scale power outage, such as that caused by a tropical storm or hurricane, the need for public service personnel to direct traffic can become overwhelming. Placement of police officers at major intersections in a municipality is extremely costly (often requiring payment of overtime), impractical, and may not even be possible depending upon the size of the police force and the number of major intersections that need traffic direction.

In view of the foregoing, there remains an urgent need for a back-up traffic light signal system that will improve traffic light directional signals at all major intersections throughout a municipality in the event of a power outage. More particularly, there remains an urgent need for a solar power traffic light signal system which can be installed on either existing traffic light signals or, alternatively, to temporary traffic light signals in order to provide traffic direction during a power outage or when the normal (i.e. permanent) traffic light signal has been damaged or destroyed.

### SUMMARY OF THE INVENTION

The present invention is directed to a solar power traffic light signal apparatus and includes one or more photo cell solar panels and a battery source for powering light directional signals during a power outage. A charger connects between the solar panels and battery source for re-charging the batteries with energy derived from the ambient light. Changing of the light directional signals (i.e. red, yellow, green, arrow) is controlled by a timer connected to the battery power source. In a preferred embodiment, one or more 12-volt batteries, such as those used in automobile, are connected in series for powering the light signals. The batteries, solar panel(s), connecting cables and the timer may be installed to an existing conventional traffic light signal or, alternatively, on a temporary traffic light signal supported on a post for placement on the ground, preferably in the middle of the road, such as at an intersection. When connected to an existing light signal that uses AC power, a DC to AC power inverter is used.

### BRIEF DESCRIPTION OF THE DRAWINGS

For a fuller understanding of the nature of the present invention, reference should be made to the detailed description taken in conjunction with the accompanying drawings in which:

FIG. 1 is a general diagram illustrating the principal components of the solar power traffic light signal of the present invention;

FIG. 2 is a elevational view illustrating one particular embodiment of the invention;

FIG. 3 is an elevational view illustrating another embodiment of the invention;

FIG. 4 is an general diagram showing the principal components of the solar power traffic light signal according to one embodiment; and

FIG. 5 is a schematic diagram of the solar power traffic light signal of FIG. 4.

Like reference numerals refer to like parts throughout the several views of the drawings.

### DETAILED DESCRIPTION OF THE PREFERRED EMBODIMENTS

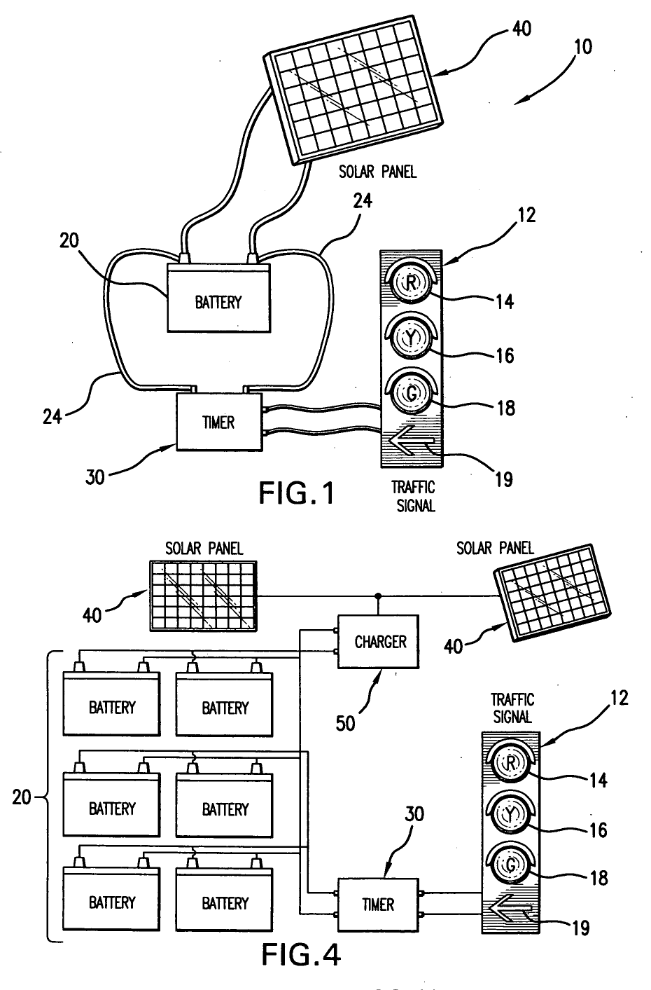

Referring to the several views of the drawings, and initially FIG. 1, the solar power traffic light signal system of the present invention is shown and is generally indicated as 10.

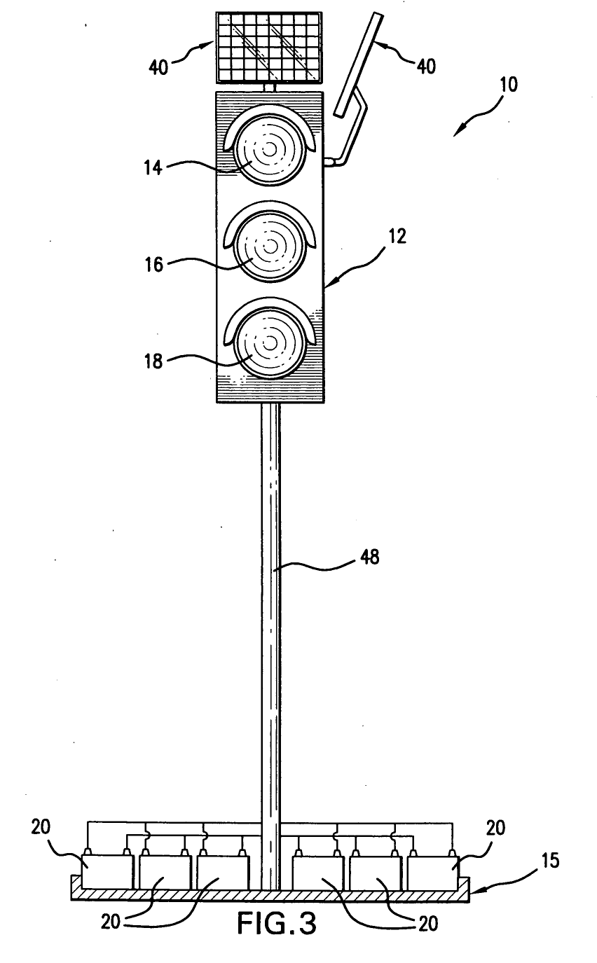

According to the system of the present invention, a traffic light signal 12 includes an arrangement of directional light signals according to conventional arrangements found on existing traffic light signals. In particular, the traffic light signal 12 includes a red light directional signal 14, a yellow light directional signal 16 and a green light directional signal 18. A turn arrow light signal 19 may also be provided as part of the traffic signal. The directional lights of the traffic signal are powered by one or more batteries 20. In a preferred embodiment, the batteries are 12 volt automobile batteries connected in series. To provide sufficient power to a multi-directional light signal at a major intersection, six or more batteries 20 may be used, connected in series, as shown in FIGS. 3 and 4. A timer 30 connects between the battery power source and the traffic signal 12 for controlling change of the light directional signals between red, yellow and green, as well as the turn signal. During daylight hours, one or more solar panels 40 harness energy from the sun's rays in order to recharge the batteries 20.

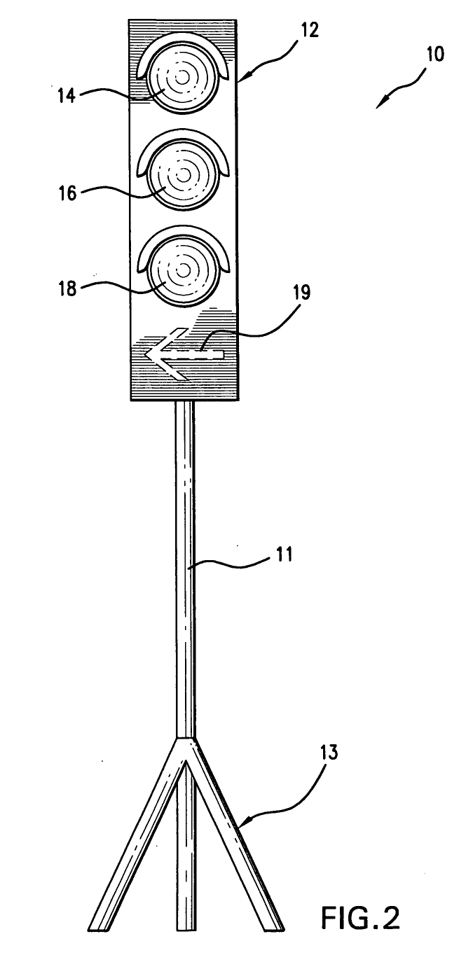

The solar power traffic light signal apparatus 10 of the present invention may be installed to an existing (i.e. conventional) traffic light signal so that, in the event of a power outage, the traffic light signal will remain operational. Alternatively, the solar power traffic light signal system 10 may be provided as a portable, temporary apparatus with the traffic light signal supported on a vertical post 11. Referring to FIG. 2, the traffic light signal 12 is shown supported on a tripod 13 for placement on the ground surface, such as in the middle of an intersection. The battery power source (as many as six or more batteries), timer and solar panel(s) may be attached directly to this portable apparatus or, alternatively, in a separate unit that may be placed along the side of the road and connected to the traffic light signal via electrical cables 24.

FIG. 3 shows another embodiment of the solar power traffic light signal system, wherein the traffic light signal 12 is supported on the vertical post 48 as a temporary apparatus, similar to the embodiment of FIG. 2. However, in the embodiment of FIG. 3, a base 15 is provided for holding the one or more batteries 20. The solar panel(s) 40 may be attached directly to the traffic light signal 12. The timer is installed internally within the traffic light signal so that entire system can be transported as a single unit, such on the back of a utility truck. The size of the base 15, and the weight of the batteries 20 on the base, helps to stabilize the traffic signal light apparatus 10 so that when placed on the street, the traffic signal 12 will remain upright and will resist wind forces and other external forces that might otherwise cause the traffic signal to tip or fall.

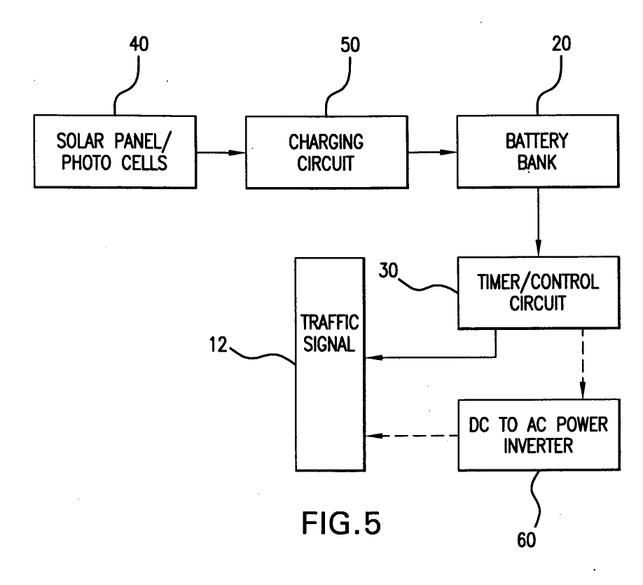

Referring to FIGS. 4 and 5, a charger 50 is connected between the solar panel(s) 40 and the battery source 20 for recharging the batteries. The timer 30 is connected to the battery bank 20 and may also be directly connected to the charger and solar panels so that the traffic signal 12 can be energized by either the solar panels or the batteries. For instance, during daylight hours, the traffic signal 12 can be energized directly from energy derived from the solar panels 40. During evening hours, the timer/control circuit 30 can switch over to battery power to energize the traffic signal 12 directly from the battery bank 20. During daylight hours, the batteries in the battery bank 20 are recharged with energy derived from the solar panels. In the instance the apparatus is connected to an existing traffic light signal, as opposed to the temporary traffic light signals shown in FIGS. 2 and 3, a DC/AC power inverter 60 may be needed (see FIG. 5).

While the present invention has been shown and described in accordance with preferred and practical embodiments thereof, it is recognized that departures from the instant disclosure are contemplated within the spirit and scope of the invention as defined in the claims which follow.

What is claimed is:

1. A traffic signal apparatus comprising:
at least one solar panel having an array of photo cells for harnessing electric energy from ambient light;
a battery power source for storing electric energy;
an arrangement of traffic light directional signals for indicating traffic directions and said traffic light directional signals being energized by electric energy from the at least one solar panel and the battery power source to operate between an ON and OFF condition; and
a timer for controlling operation of the traffic light directional signals between the ON and OFF conditions.

2. The traffic signal apparatus as recited in claim 1 wherein said arrangement of traffic light directional signals includes a red light, a yellow light and a green light.

3. The traffic signal apparatus as recited in claim 1 further comprising a charger for recharging said battery power source with the electric energy harnessed by said at least one solar panel.

4. The traffic signal apparatus as recited in claim 1 wherein said battery power source includes a plurality of batteries.

5. The traffic signal apparatus as recited in claim 4 wherein said plurality of batteries are 12 volt batteries.

6. The traffic signal apparatus as recited in claim 1 further comprising:
a base for supporting said apparatus on a ground surface;
a vertical post extending upwardly from said base; and
said arrangement of traffic light directional signals being supported on said vertical post.

7. The traffic signal apparatus as recited in claim 6 wherein said battery power source is on said base.

8. An apparatus for providing electric power to a traffic light signal, said apparatus comprising:
at least one solar panel having an array of photo cells for harnessing electric energy from ambient light;
a battery power source for storing electric energy;
a charger for recharging said battery power source with the electric energy harnessed by said at least one solar panel; and
a timer connected to said battery power source for controlling operation of the traffic light signal.

9. The apparatus as recited in claim 8 wherein said battery power source includes a plurality of batteries.

10. The apparatus as recited in claim 8 further comprising:
a DC to AC power inverter for providing AC power to the traffic light signal.

11. The apparatus as recited in claim 8 further comprising:
a plurality of said solar panels supported and arranged at different angular positions.

12. A traffic signal apparatus comprising:
at least one solar panel having an array of photo cells for harnessing electric energy from ambient light;
a battery power source for storing electric energy;
a charger for recharging said battery power source with the electric energy harnessed by said at least one solar panel;
a base for supporting said apparatus on a ground surface;
a vertical support structure on said base;
a traffic signal device supported on said vertical support structure and including an arrangement of traffic light directional signals for indicating traffic directions, and said traffic light directional signals being energized by said battery power source; and
a timer connected to said battery power source for controlling operation of the traffic light directional signals.

13. The traffic signal apparatus as recited in claim 12 wherein said arrangement of traffic light directional signals includes a red light, a yellow light and a green light.

14. The traffic signal apparatus as recited in claim 12 wherein said battery power source includes a plurality of batteries.

15. The traffic signal apparatus as recited in claim 12 wherein said battery power source is positioned on said base.
